(19) United States
(12) Patent Application Publication
(10) Pub. No.: US 2026/0220531 A1
(43) Pub. Date: Jul. 30, 2026

(54) EXPLAINABLE MACHINE-LEARNING TECHNIQUES FROM MULTIPLE DATA SOURCES

(71) Applicant: EQUIFAX INC., Atlanta, GA (US)

(72) Inventor: Stephen Miller, Guiseley (GB)

(21) Appl. No.: 19/141,877

(22) PCT Filed: Dec. 23, 2022
(86) PCT No.: PCT/US2022/082376

§ 371 Date: Jun. 20, 2025

(51) Int. Cl. G06N 20/00; G06N 5/045

(52) U.S. Cl. CPC G06N 20/00; G06N 5/045

(57) ABSTRACT

In some aspects, a computing system can generate and optimize a hybrid machine learning model for risk assessment based on predictor variables associated with a target entity. The hybrid machine learning model can be trained using training vectors with sets of training predictor variables and training outputs corresponding to the respective sets of training predictor variables. The predictor variables associated with the target entity may include unknown values and the training predictor variables or trainings output may also include unknown values. Additionally, the computing system can generate explanatory data for the target entity to indicate relationships between changes in the risk indicator and changes in the predictor variables associated with the target entity. The risk indicator and the explanatory data can be used in controlling access of the target entity to interactive computing environments.

### TECHNICAL FIELD

The present disclosure relates generally to artificial intelligence. More specifically, but not by way of limitation, this disclosure relates to machine learning using hybrid models from multiple data sources for emulating intelligence that are trained for assessing risks or performing other operations and for providing explainable outcomes associated with these outputs.

### BACKGROUND

In machine learning, models can be used to perform one or more functions (e.g., acquiring, processing, analyzing, and understanding various inputs in order to produce an output that includes numerical or symbolic information). A machine learning model, such as a neural network, includes one or more algorithms and interconnected components that exchange data between one another. The model can have numeric parameters that can be tuned based on experience, which makes the model adaptive and capable of learning. For example, the numeric weights of a neural network can be used to train the neural network such that the neural network can perform the one or more functions on a set of input variables and produce an output that is associated with the set of input variables.

### SUMMARY

Various aspects of the present disclosure provide systems and methods for optimizing a hybrid model for risk assessment and outcome prediction from multiple data sources. In one example, a method is performed by one or more processing devices. The method includes determining, using a hybrid machine learning model trained using a training process, a risk indicator for a target entity from predictor variables associated with the target entity, wherein the risk indicator indicates a level of risk associated with the target entity, wherein the training process includes operations comprising: accessing training vectors having a plurality of sets of training predictor variables and a plurality of training outputs corresponding to the respective sets of training predictor variables; and performing iterative adjustments of parameters of the hybrid machine learning model to minimize a loss function of the hybrid machine learning model, wherein the loss function comprises a first term representing a discriminative loss and a second term representing a generative loss, wherein a value of a predictor variable in the predictor variables associated with the target entity is unknown or a value of a training predictor variable or a training output in the training vectors is unknown; generating, for the target entity, explanatory data indicating relationships between changes in the risk indicator and changes in at least some of the predictor variables associated with the target entity; and transmitting, to a remote computing device, a responsive message including at least the risk indicator and the explanatory data for use in controlling access of the target entity to one or more interactive computing environments.

In another example, a system includes a processing device; and a memory device in which instructions executable by the processing device are stored for causing the processing device to: determine, using a hybrid machine learning model trained using a training process, a risk indicator for a target entity from predictor variables associated with the target entity, wherein the risk indicator indicates a level of risk associated with the target entity, wherein the training process includes operations comprising: accessing training vectors having a plurality of sets of training predictor variables and a plurality of training outputs corresponding to the respective sets of training predictor variables; and performing iterative adjustments of parameters of the hybrid machine learning model to minimize a loss function of the hybrid machine learning model, wherein the loss function comprises a first term representing a discriminative loss and a second term representing a generative loss, wherein a value of a predictor variable in the predictor variables associated with the target entity is unknown or a value of a training predictor variable or a training output in the training vectors is unknown; generate, for the target entity, explanatory data indicating relationships between changes in the risk indicator and changes in at least some of the predictor variables associated with the target entity; and transmit, to a remote computing device, a responsive message including at least the risk indicator and the explanatory data for use in controlling access of the target entity to one or more interactive computing environments.

In yet another example, a non-transitory computer-readable storage medium has program code that is executable by a processor to cause a computing device to perform operations. The operations comprise: determining, using a hybrid machine learning model trained using a training process, a risk indicator for a target entity from predictor variables associated with the target entity, wherein the risk indicator indicates a level of risk associated with the target entity, wherein the training process comprises: accessing training vectors having a plurality of sets of training predictor variables and a plurality of training outputs corresponding to the respective sets of training predictor variables; performing iterative adjustments of parameters of the hybrid machine learning model to minimize a loss function of the hybrid machine learning model, wherein the loss function comprises a first term representing a discriminative loss and a second term representing a generative loss, wherein a value of a predictor variable in the predictor variables associated with the target entity is unknown or a value of a training predictor variable or a training output in the training vectors is unknown; generating, for the target entity, explanatory data indicating relationships between changes in the risk indicator and changes in at least some of the predictor variables associated with the target entity; and transmitting, to a remote computing device, a responsive message including at least the risk indicator and the explanatory data for use in controlling access of the target entity to one or more interactive computing environments.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment in which a hybrid model can be trained and applied in a risk assessment application according to certain aspects of the present disclosure.

FIG. 2 is a flow chart depicting an example of a process for utilizing a hybrid model to generate risk indicators for a target entity based on predictor variables associated with the target entity according to certain aspects of the present disclosure.

FIG. 3A is a diagram depicting an example of a graphical representation of a discriminative model, according to certain aspects of the present disclosure.

FIG. 3B is a diagram depicting an example of a graphical representation of a generative model, according to certain aspects of the present disclosure.

FIG. 4 is a diagram depicting an example of a graphical representation of a hybrid machine learning model, according to certain aspects of the present disclosure.

FIG. 5 is a block diagram depicting an example of a computing system suitable for implementing aspects of the techniques and technologies presented herein.

### DETAILED DESCRIPTION

Machine learning models may be constructed using variables from multiple data sources, either by building a raw model (a new model using variables from all sources), a fusion model (combining outputs, each based on one data source or a subset of data sources) or an embedded model (combining an output based on a subset of data sources with new variables from additional data sources). However, a model built with variables from n data sources requires all n sources to be present in order to make predictions. To make predictions with any subset of the data sources, 2ⁿ−1 models are required: one for each combination of data sources, excluding the empty set. As n grows large, this becomes infeasible. For example, as few as 5 data sources would require 31 separate models to be maintained. The number of models required is exponential in the number of data sources.

A class of hybrid generative-discriminative models that enable prediction of an uncertain quantity, such as a binary risk assessment outcome, is described herein. The model describes the relationship between the outcome variable and multiple explanatory data sources and predictions of the outcome variable may be made using any subset of those data sources. In some examples, the models are linear in the sense that the predictions of the outcome variable or log odds in examples of a binary outcome variable are linear functions of the available explanatory variables. The models are explainable because the linear predictive functions can be constrained to have only positive coefficients, preserving the expected relationships between each explanatory variable and the outcome, and hence enabling local model explanations to be generated using techniques such as Points Below Max and Integrated Gradients.

Certain aspects described herein use a latent factor decomposition of the explanatory variables from multiple data sources. The predictive output can then be a linear combination of the estimated (posterior) values of factor scores. The factor scores can be calculated from any subset of the data sources used to train the model. This overcomes the problem of maintaining separate models for each combination of data sources. In other words, the model can be trained and used for prediction even if data from certain data sources are missing.

The latent factors in the model are required to be predictive of the values of the explanatory variables and of the outcome variable. Generally speaking, there can be many explanatory variables and one outcome variable. In a simple generative model, the ability of the factors to predict the outcome variable would be given equal importance in training to their ability to predict each explanatory variable. This would result in poor predictive performance. By adopting a hybrid model formulation with multi-conditional likelihood, the technique proposed herein ensures the predictive performance of the model is given high importance in training. The loss function of the hybrid model thus can include two terms, one for a generative component of the model and one for a discriminative component of the model. To achieve the explainability of the model, monotonicity between predictor variables and the outcome variable may be enforced during a training process of the model. Additionally, or alternatively, monotonicity between the factors and the outcome variable may be enforced during the training of the model. In examples where only a subset of predictor variables is available to the prediction (e.g., some predictor variables have missing or unknown values), the monotonicity can be achieved by using non-negative least squares to identify a non-negative linear operator for the available subset of predictor values and use the identified non-negative linear operator to provide the prediction based on the trained model. Different non-negative linear operators can be identified for different subsets of predictor variables. In these examples, the model can be trained with or without the monotonicity constraints.

Certain aspects described herein provide improvements to machine learning techniques for assessing risks, for example, in access control associated with entities. For instance, by using a latent factor decomposition of the predictor variables, the hybrid model presented herein can be built based on data from multiple sources without generating separate models. This leads to significant reduction in the computational resource consumption associated with training and maintaining the multiple models, including the CPU consumptions, memory usage and so on. Implementing the hybrid model additionally can increase statistical robustness in certain aspects in which training data is insufficient to successfully train a model for each combination of data sources. Further, using the hybrid model formulation increases the predictive performance of the model compared to the generative model or the discriminative model. In addition, by enforcing the monotonicity between the predictor variables and of the outcome variable or between the factors and the outcome variable, the explainability of the model can be achieved during the training of the model. This allows using the same model to predict an outcome and to generate explainable reasons for the predicted outcome. Further, the interpretability of the model makes the predicted outcome explainable and allows entities to improve their respective predictor variables thereby obtaining desired access control decisions or other decisions.

Additional or alternative aspects can implement or apply rules of a particular type that improve existing technological processes involving machine-learning techniques. For instance, to enforce the monotonicity of the model, a particular set of rules are employed in the training of the model. This particular set of rules allow the monotonicity to be introduced by constraining certain parameters to be non-negative, which allows the training of the model to be performed more efficiently without any post-training adjustment.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Machine-Learning Operations

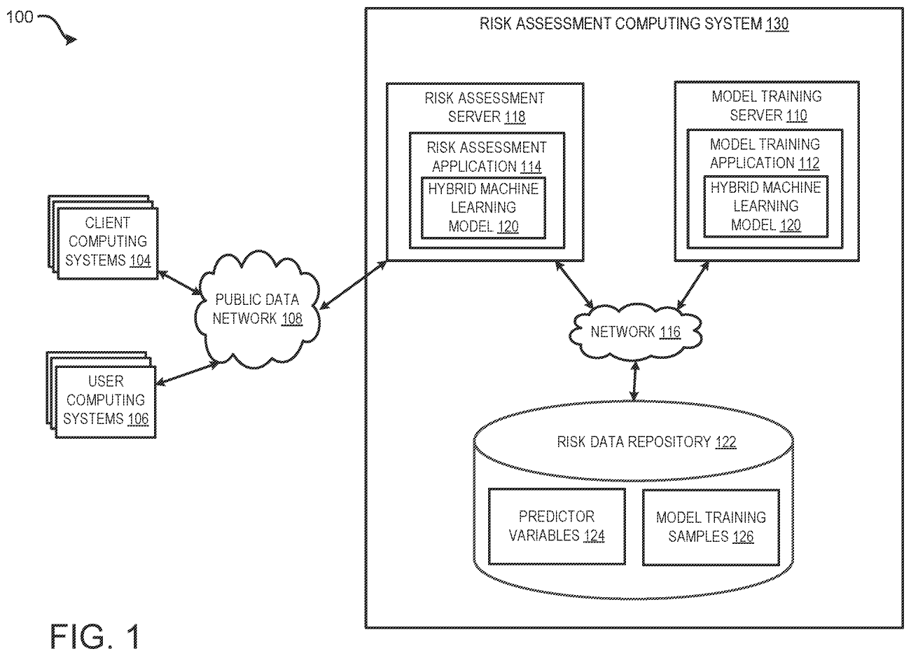

Referring now to the drawings, FIG. 1 is a block diagram depicting an example of an operating environment 100 in which a risk assessment computing system 130 builds and trains a hybrid model that can be utilized to predict risk indicators based on predictor variables. FIG. 1 depicts examples of hardware components of a risk assessment computing system 130, according to some aspects. The risk assessment computing system 130 is a specialized computing system that may be used for processing large amounts of data using a large number of computer processing cycles. The risk assessment computing system 130 can include a model training server 110 for building and training a hybrid machine learning model (or hybrid model 120 in short) wherein input predictor variables 124 of the hybrid model 120 or factors of the input predictor variables 124 have a monotonic relationship with the output of the hybrid model 120. The risk assessment computing system 130 can further include a risk assessment server 118 for performing a risk assessment for given predictor variables 124 using the trained hybrid model 120.

The model training server 110 can include one or more processing devices that execute program code, such as a model training application 112. The program code is stored on a non-transitory computer-readable medium. The model training application 112 can execute one or more processes to train and optimize a hybrid model 120 for predicting risk indicators based on predictor variables 124 and maintaining a monotonic relationship between the factors of the predictor variables 124 and the predicted risk indicators.

In some aspects, the model training application 112 can build and train a hybrid model 120 utilizing model training samples 126 in a training process. The model training samples 126 can include multiple training vectors including training predictor variables and training risk indicator outputs corresponding to the training vectors. In some cases, the model training samples 126 may include differing subsets of data sources available. The model training samples 126 can be stored in one or more network-attached storage units on which various repositories, databases, or other structures are stored. Examples of these data structures are the risk data repository 122.

Network-attached storage units may store a variety of different types of data organized in a variety of different ways and from a variety of different sources. For example, the network-attached storage unit may include storage other than primary storage located within the model training server 110 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory, or memory devices.

The risk assessment server 118 can include one or more processing devices that execute program code, such as a risk assessment application 114. The program code is stored on a non-transitory computer-readable medium. The risk assessment application 114 can execute one or more processes to utilize the hybrid model 120 trained by the model training application 112 to predict risk indicators based on input predictor variables 124. By using latent factor decomposition of the predictor variables 124, the hybrid model 120 predict the risk indicators even if the predictor variables 124 are obtained from more than one data source. Thus, using the hybrid model 120 can decrease the computing and storage resources of training and maintaining machine learning models used to generate the risk indicators for combinations of data sources. The risk assessment computing system 130 therefore can manage relatively fewer machine learning models, enabling allocation of limited computing resources to other computing processes. In addition, the hybrid model 120 can also be utilized to generate explanation codes for the predictor variables 124, which indicate an effect or an amount of impact that one or more predictor variables have on the risk indicator.

Furthermore, the risk assessment computing system 130 can communicate with various other computing systems, such as client computing systems 104. For example, client computing systems 104 may send risk assessment queries to the risk assessment server 118 for risk assessment, or may send signals to the risk assessment server 118 that control or otherwise influence different aspects of the risk assessment computing system 130. The client computing systems 104 may also interact with user computing systems 106 via one or more public data networks 108 to facilitate interactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronics transactions between the user computing system 106 and the client computing system 104 to be performed.

In some examples, a client computing system 104 may have other computing resources associated therewith (not shown in FIG. 1), such as server computers hosting and managing virtual machine instances for providing cloud computing services, server computers hosting and managing online storage resources for users, server computers for providing database services, and others. The interaction between the user computing system 106 and the client computing system 104 may be performed through graphical user interfaces presented by the client computing system 104 to the user computing system 106, or through application programming interface (API) calls or web service calls.

A user computing system 106 can include any computing device or other communication device operated by an entity, such as a user, an organization, or a company. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104 or other computing resources, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to request online storage resources managed by the client computing system 104, acquire cloud computing resources (e.g., virtual machine instances), and so on. An electronic transaction between the user computing system 106 and the client computing system 104 can also include, for example, querying a set of sensitive or other controlled data, accessing online financial services provided via the interactive computing environment, submitting an online credit card application or other digital application to the client computing system 104 via the interactive computing environment, operating an electronic tool within an interactive computing environment hosted by the client computing system (e.g., a content-modification feature, an application-processing feature, etc.).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and communicate with the risk assessment server 118 for risk assessment. Based on the risk indicator predicted by the risk assessment server 118, the client computing system 104 can determine whether to grant the access request of the user computing system 106 to certain features of the interactive computing environment.

In a simplified example, the system depicted in FIG. 1 can configure a hybrid model 120 to be used both for accurately determining risk indicators, such as credit scores, using predictor variables 124 and determining adverse action codes or other explanation codes for the predictor variables 124. A predictor variable 124 can be any variable predictive of risk that is associated with an entity. Any suitable predictor variable that is authorized for use by an appropriate legal or regulatory framework may be used.

Examples of predictor variables 124 used for predicting the risk associated with an entity accessing online resources include, but are not limited to, variables indicating the demographic characteristics of the entity (e.g., name of the entity, the network or physical address of the company, the identification of the company, the revenue of the company), variables indicative of prior actions or transactions involving the entity (e.g., past requests of online resources submitted by the entity, the amount of online resource currently held by the entity, and so on.), variables indicative of one or more behavioral traits of an entity (e.g., the timeliness of the entity releasing the online resources), etc. Similarly, examples of predictor variables 124 used for predicting the risk associated with an entity accessing services provided by a financial institute include, but are not limited to, indicative of one or more demographic characteristics of an entity (e.g., age, gender, income, etc.), variables indicative of prior actions or transactions involving the entity (e.g., information that can be obtained from credit files or records, financial records, consumer records, or other data about the activities or characteristics of the entity), variables indicative of one or more behavioral traits of an entity, etc.

The predicted risk indicator can be utilized by the service provider to determine the risk associated with the entity accessing a service provided by the service provider, thereby granting or denying access by the entity to an interactive computing environment implementing the service. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

Each communication within the operating environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the model training server 110 and the risk assessment server 118, may be instead implemented in a signal device or system.

### Examples of Operations Involving Machine-Learning

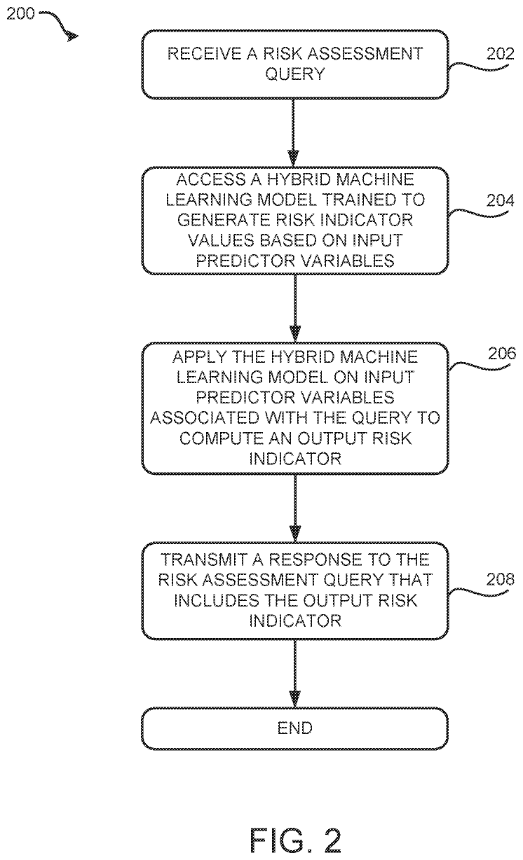

FIG. 2 is a flow chart depicting an example of a process 200 for utilizing a hybrid model 120 to generate risk indicators for a target entity based on predictor variables associated with the target entity. One or more computing devices (e.g., the risk assessment server 118) implement operations depicted in FIG. 2 by executing suitable program code (e.g., the risk assessment application 114). For illustrative purposes, the process 200 is described with reference to certain examples depicted in the figures. Other implementations, however, are possible.

At block 202, the process 200 involves receiving a risk assessment query for a target entity from a remote computing device, such as a computing device associated with the target entity requesting the risk assessment. The risk assessment query can also be received by the risk assessment server 118 from a remote computing device associated with an entity authorized to request risk assessment of the target entity.

At operation 204, the process 200 involves accessing a hybrid machine learning model 120 trained to generate risk indicator values based on input predictor variables (e.g., the predictor variables 124 of FIG. 1) or other data suitable for assessing risks associated with an entity. Examples of predictor variables can include data associated with an entity that describes prior actions or transactions involving the entity (e.g., information that can be obtained from credit files or records, financial records, consumer records, or other data about the activities or characteristics of the entity), behavioral traits of the entity, demographic traits of the entity, or any other traits that may be used to predict risks associated with the entity. In some aspects, predictor variables can be obtained from credit files, financial records, consumer records, etc. The risk indicator can indicate a level of risk associated with the entity, for example with respect to accessing protected computing resources. An example of the level of risk can include a credit score of the entity.

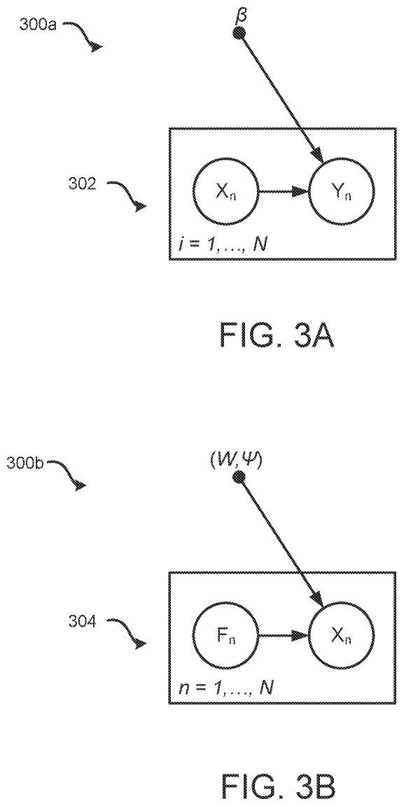

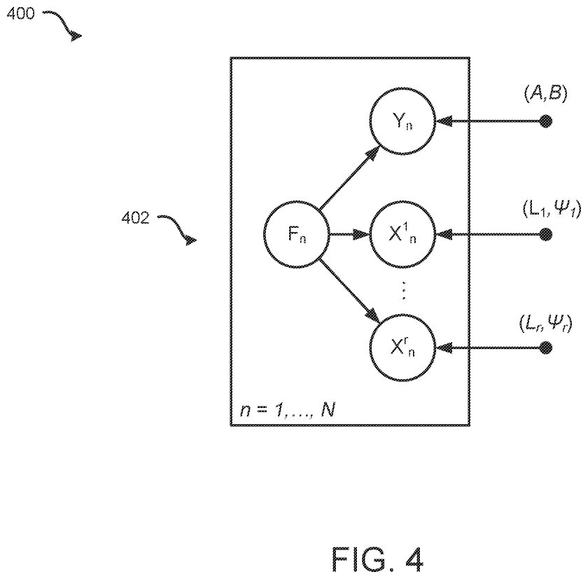

The hybrid model 120 can be constructed and trained based on training samples (e.g., the model training samples 126 of FIG. 1) including training predictor variables and training risk indicator outputs. For example, the hybrid model 120 can access training vectors that include a plurality of sets of training predictor variables. The training vectors additionally can include a plurality of training outputs corresponding to the respective sets of training predictor variables. In some aspects, the training vectors can include at least one particular training vector in which a value of at least one predictor variable or training output is unknown. Constraints can be imposed on the training of the hybrid model 120 so that the hybrid model 120 maintains a monotonic relationship between factors of the input predictor variables and the risk indicator outputs or between input predictor variables and the risk indicator outputs. Additional details regarding training the hybrid model 120 will be presented below with regard to FIGS. 3 and 4.

At operation 206, the process 200 involves applying the hybrid model 120 to generate a risk indicator for the target entity specified in the risk assessment query. Predictor variables associated with the target entity can be used as inputs to the hybrid model 120. The predictor variables associated with the target entity can be obtained from a predictor variable database configured to store predictor variables associated with various entities. The output of the hybrid model 120 can include the risk indicator for the target entity based on its current predictor variables.

At operation 208, the process 200 involves generating and transmitting a response to the risk assessment query. The response can include the risk indicator generated using the hybrid model 120. The risk indicator can be used for one or more operations that involve performing an operation with respect to the target entity based on a predicted risk associated with the target entity. In one example, the risk indicator can be utilized to control access to one or more interactive computing environments by the target entity. As discussed above with regard to FIG. 1, the risk assessment computing system 130 can communicate with client computing systems 104, which may send risk assessment queries to the risk assessment server 118 to request risk assessment. The client computing systems 104 may be associated with technological providers, such as cloud computing providers, online storage providers, or financial institutions such as banks, credit unions, credit-card companies, insurance companies, or other types of organizations. The client computing systems 104 may be implemented to provide interactive computing environments for customers to access various services offered by these service providers. Customers can utilize user computing systems 106 to access the interactive computing environments thereby accessing the services provided by these providers.

For example, a customer can submit a request to access the interactive computing environment using a user computing system 106. Based on the request, the client computing system 104 can generate and submit a risk assessment query for the customer to the risk assessment server 118. The risk assessment query can include, for example, an identity of the customer and other information associated with the customer that can be utilized to generate predictor variables. The risk assessment server 118 can perform a risk assessment based on predictor variables generated for the customer and return a responsive message to the client computing system 104. The responsive message can include at least the risk indicator and explanatory data associated with the risk indicator.

Based on the received risk indicator, the client computing system 104 can determine whether to grant the customer access to the interactive computing environment. If the client computing system 104 determines that the level of risk associated with the customer accessing the interactive computing environment and the associated technical or financial service is too high, the client computing system 104 can deny access by the customer to the interactive computing environment. Conversely, if the client computing system 104 determines that the level of risk associated with the customer is acceptable, the client computing system 104 can grant access to the interactive computing environment by the customer and the customer would be able to utilize the various services provided by the service providers. For example, with the granted access, the customer can utilize the user computing system 106 to access clouding computing resources, online storage resources, web pages or other user interfaces provided by the client computing system 104 to execute applications, store data, query data, submit an online digital application, operate electronic tools, or perform various other operations within the interactive computing environment hosted by the client computing system 104.

In additional or alternative examples, the hybrid model 120 can be utilized to generate adverse action codes or other explanation codes for the predictor variables. Adverse action code can indicate an effect or an amount of impact that a predictor variable has or a group of predictor variables have on the value of the risk indicator, such as credit score (e.g., the relative negative impact of the predictor variable(s) on a risk indicator such as the credit score). In some aspects, the risk assessment application 114 uses the hybrid model 120 to provide adverse action codes that are compliant with regulations, business policies, or other criteria used to generate risk evaluations. Examples of regulations to which the hybrid model conforms and other legal requirements include the Equal Credit Opportunity Act (“ECOA”), Regulation B, and reporting requirements associated with ECOA, the Fair Credit Reporting Act (“FCRA”), the Dodd-Frank Act, and the Office of the Comptroller of the Currency (“OCC”).

In some implementations, the explanation codes can be generated for a subset of the predictor variables that have the highest impact on the risk indicator. For example, the risk assessment application 114 can determine the rank of each predictor variable based on the impact of the predictor variable on the risk indicator. A subset of the predictor variables including a certain number of highest-ranked predictor variables can be selected and explanation codes can be generated for the selected predictor variables. The risk assessment application 114 may provide recommendations to a target entity based on the generated explanation codes. The recommendations may indicate one or more actions that the target entity can take to improve the risk indicator (e.g., improve a credit score).

### Example of Hybrid Machine Learning Model

FIG. 3A is a diagram depicting an example of a graphical representation 300a of a discriminative model 302, according to certain aspects of the present disclosure. The discriminative model can make a prediction of an uncertain quantity Y given access to a vector of explanatory variables X=(X₁, . . . , Xₚ). To make the prediction, the discriminative model 302 can use a function ƒ(X) that yields either a single predicted value Ŷ=ƒ(X) or parameters of a predictive probability distribution p(Y|X)=p(Y|ƒ(X)). In some aspects, the parameters of the predictive probability distribution can include the mean Ŷ=E(Y|X). Training a predictive model can involve optimizing the function ƒ(X), for example by optimizing a set of weights Θ in order to minimize a loss function L(X, Y|Θ) measured on a training dataset where observations of both X and Y are available. When the predictive model produces a predictive distribution p(Y|X), the loss function may represent a negative log-likelihood of the training dataset, as defined by equation (1) shown below:

$$L ( X , Y \vert Θ ) = - \frac{1}{N} {\sum }_{n = 1}^{N} log p ( {Y}_{n} \vert {X}_{n} , θ ) \qquad ( 1 )$$

The loss function being the negative log-likelihood of the training dataset can lead to Maximum Likelihood Estimation (MLE). The MLE may be an estimate from data of an expected negative log-likelihood, as defined by equations (2) and (3) shown below:

$$L ( X , Y \vert Θ ) = - E [ log p ( Y \vert X , Θ ) ] \qquad ( 2 )$$

$$\hat{L} ( X , Y \vert Θ ) = - \frac{1}{N} {\sum }_{n = 1}^{N} log p ( {Y}_{n} \vert {X}_{n} , Θ ) \qquad ( 3 )$$

For example, a linear regression model can produce a prediction, as defined by equation (4) below:

$$\hat{Y} = {β}_{0} + {\sum }_{i = 1}^{p} {β}_{i} {X}_{i} \qquad ( 4 )$$

with weight vector β and the usual loss function is the sum of squares errors

$${\sum }_{n = 1}^{N} {( {Y}_{n} - {\hat{Y}}_{n} )}^{2} .$$

The least squares estimate can arise from the MLE when a predictive distribution is taken to be Gaussian p(Y|X)~ [symbol] (Ŷ, σ²) and σ is an additional model weight to be optimized. In logistic regression, the outcome variable Y may be binary, taking values zero or one, and the linear regression model can predict Ŷ=E(Y|X)=p(Y=1|X), leading to equation (5) shown below:

$$\hat{Y} = σ ( {β}_{0} + {\sum }_{i = 1}^{p} {β}_{i} {X}_{i} i ) \qquad ( 5 )$$

where σ is the sigmoid function, as defined below by equation (6):

$$σ ( x ) = \frac{1}{1 + {e}^{- x}} \qquad ( 6 )$$

and the weight vector β is fit by MLE.

As depicted in FIG. 3A, both linear regression models and logistic regression models can be represented as probabilistic graphical models (PGMs) in a same graph. The pre-observation explanatory variables X_{·n} and weights β can be treated as single variables to simplify the PGMs. The weight vector β=(β₀, . . . , βₚ) can be represented as a parameter of the model, and the explanatory variables X_{·n}=(X₁ₙ, . . . , Xₚₙ) and outcome variable Yₙ for observations n=1, . . . , N can be represented as observed variables. One or more plates can represent multiple observations n=1, . . . , N, multiple explanatory variables i=1, . . . , p, or multiple weights i=0, . . . , p. The directed edges can illustrate a dependency of Yₙ on X_{·n} and β. Unlike generative models, discriminative models can only describe marginal distribution p(Y|X) given observations of X. The discriminative models generally may not assume any particular distribution for the explanatory variable(s) X.

FIG. 3B is a diagram depicting an example of a graphical representation 300b of a generative model 304, according to certain aspects of the present disclosure. Generative models may be used for unsupervised learning tasks, such as clustering or noise reduction. A generative model 304 can describe a distribution of one or more variables X=(X₁, . . . , Xₚ) via a probability density function p(X). Training the generative model 304 may involve optimizing p(X), which may be a parametric function whose weights Θ are to be found, to minimize a loss function L(X|Θ) that may be estimated by the negative log-likelihood of the training data, as defined previously in equation (7):

$$\hat{L} ( X \vert Θ ) = - \frac{1}{N} {\sum }_{n = 1}^{N} log p ( X {.}_{n} ) \qquad ( 7 )$$

In additional or alternative examples, other loss functions, such as Kullback-Leibler divergence, may be used.

An example of the generative model 304 can include factor analysis. A factor analysis model can explain a correlation between a set of variables X=(X₁, . . . , Xₚ) via a smaller number of common factors Z=(Z₁, . . . , Zₖ). The factor analysis model can assume a latent factor vector Z is a k-dimensional standard Gaussian variable Z~ [symbol] (0, Iₖ). Additionally, the factor analysis model can assume a conditional distribution p(X|Z) is Gaussian with mean μ+WZ and variance Y, i.e. X~ [symbol] (μ+WZ, ψ) where μ is the observed mean of X, W is a (p×k) factor loading matrix, and ω is a non-negative diagonal matrix of dimension p. This can result in an overall probability density for X that is Gaussian, as defined in equation (8) below:

$$X ∼ 𝒩 ( μ , {WW}^{T} + Ψ ) \qquad ( 8 )$$

Fitting the factor analysis model can involve finding values for W and ψ that give a suitable decomposition of the observed covariance matrix \hat{Σ}=Cov[X]≈ŴŴ^{T}+\hat{ψ}. This can be achieved by the MLE, minimizing the loss function, as defined below in equation (9):

$$\hat{L} ( X \vert W , Ψ ) = - \frac{1}{N} {\sum }_{n = 1}^{N} log p ( X {.}_{n} ) = \frac{1}{2 N} {\sum }_{n = 1}^{N} ( {( X {.}_{n} - μ )}^{T} {( W {W}^{T} + Ψ )}^{- 1} ( X {.}_{n} - μ ) ) + \frac{1}{2} log \vert {WW}^{T} + Ψ \vert + C \qquad ( 9 )$$

where C is a term that does not depend on W or ψ. The loss function may be minimized using a numerical optimizer, such as RMSProp or Adam. Alternatively, as factor analysis is a latent variable model, an EM-algorithm may be used.

The generative model 304 may be used for prediction of unknown quantities. Given a generative model with complete data including explanatory variables X and outcome variable Y via a density function p(Y,X), a marginal distribution can be calculated, as defined below in equation 10:

$$p ( Y \vert X ) = \frac{p ( Y , X )}{p ( X )} = \frac{p ( Y , X )}{\int p ( Y , X ) dY} \qquad ( 10 )$$

which may be tractable depending on the form of the generative model 304. In some aspects, discriminative models may be preferred over generative models for predictive purposes. For example, the discriminative models may be computationally simpler and may require fewer assumptions (and related diagnostic checks) to be made. Additionally, the discriminative models can be more robust to violations of model assumptions. Furthermore, as the discriminative models are optimized specifically for a predictive task, the discriminative models may outperform the generative models. In summary, the generative models may fail to have good predictive performance if distributional assumptions about the explanatory variables do not hold.

However, the generative models can retain some advantages over the discriminative models. In some examples, the generative model 304 can perform inference when some of the model variables are unknown. For example, if only a subset of entries X⁺=(Xᵢ_{₁}, . . . , Xᵢ_{_{q}}) of a vector X=(X₁, . . . , Xₚ) are observed, the probability density function p(Y,X) may be reduced to the subset X⁺⊂X by integrating over the missing variables X⁻=X\X⁺, as defined below in equation (11):

$$p ( Y , {X}^{+} ) = \int p ( Y , {X}^{+} , {X}^{-} ) d {X}^{-} \qquad ( 11 )$$

This can yield a new predictive model, defined below as equation (12):

$$p ( Y \vert {X}^{+} ) = \frac{p ( Y , {X}^{+} )}{p ( {X}^{+} )} \qquad ( 12 )$$

which may be tractable, depending on the form of the generative model and the subset X⁺. Therefore, certain classes of generative models may allow making predictions when some of the explanatory variables are missing.

Additionally, generative models may directly support imputation. Rather than integrating out missing variables as described above, the missing variables may be replaced with imputed values derived from the same generative model, taking equation (13) as defined below:

$$\text{?} = E [ {X}^{-} \vert {X}^{+} ] = \int {X}^{-} p ( Y , {X}^{+} , {X}^{-} ) d {X}^{-} dY \qquad ( 13 )$$

Finally, since generative models can potentially account for arbitrary correlations or dependencies between the explanatory variables, the generative model 304 can be used with highly correlated data without variable reduction. This can enable information from all variables to be used for prediction, not only a selected subset.

FIG. 4 is a diagram depicting an example of a graphical representation 400 of a hybrid machine learning model 120, according to certain aspects of the present disclosure. The hybrid model 120 can include machine learning models trained to perform both a generative task and a discriminative task, where different levels of importance may be given to each of these tasks. This can be achieved by assigning different weights to each part of a loss function when training the hybrid model 120. For example, given a generative model 304 with complete data including explanatory variables X and outcome variable Y via a density function p(Y,X|Θ)=p(Y|X,Θ)p(X|Θ), a multi-conditional likelihood and log-likelihood can be formed, as depicted in equation (14) below:

$$Log ( {p ( Y \vert X , Θ )}^{α} {p ( X \vert Θ )}^{β} ) = α log ( p ( Y \vert X , Θ ) ) + β log ( p ( X \vert Θ ) ) ) \qquad ( 14 )$$

β in equation (14) can represent a weight instead of a vector of parameters as described with reference to FIG. 3A above. By increasing a weight α relative to β, more importance can be assigned to the discriminative loss −log(p(Y|X, Θ)) than the generative loss −log(p(X|Θ)). When there are many explanatory variables in X and only a single outcome variable Y, the unweighted loss function can be dominated by the generative loss term. Up-weighting the discriminative loss term can improve a predictive power of the hybrid model 120.

An alternative formulation of the multi-conditional likelihood can be used with a latent variable model, such as the factor model. In such cases, explanatory variables X and outcome variable Y can be related via a latent (unobserved) set of variables Z by p(X, Y, Z)=p(Y|X,Z)p(X|Z)p(Z) or p(X, Y, Z)=p(Y|Z)p(X|Z)p(Z). As Z is unobserved, a complete data likelihood p(X, Y, Z) may be uncalculable. Instead a marginal log-likelihood may be maximized, as defined by equation 15 below:

$$log \int p ( X , Y , Z ) dZ = log \int p ( Y \vert X , Z ) p ( X \vert Z ) p ( Z ) d Z \qquad ( 15 )$$

where Θ is omitted for clarity. This may be replaced by the multi-conditional likelihood, as defined below by equation 16:

$$log \int {p ( Y \vert X , Z )}^{γ} p ( X \vert Z ) p ( Z ) d Z \qquad ( 16 )$$

Here, the scalar γ can replace the ratio α/β.

Reweighting the likelihood function can also be applied to subsets of the explanatory variables. This can be applied, for example, when a number of explanatory variables of a particular type or from a particular source outweighs other sources. In the context of a latent variable model, an objective function may be defined as in equation 17 below:

$$log \int {p ( Y \vert {X}^{1} , … , {X}^{r} , Z )}^{γ} {\prod }_{i} {P ( {X}^{i} \vert Z )}^{{β}_{i}} p ( Z ) d Z \qquad ( 17 )$$

where X¹, . . . , X^{T} are different subsets of the explanatory variables that are assumed to be conditionally independent given a value of Z. If the latent variable model is used in credit-risk modeling, down-weighting an importance of certain data in the loss function may be an alternative to variable reduction. Maximizing multi-conditional likelihood or minimizing negative multi-conditional log-likelihood or other hybrid loss functions can involve a toolbox of techniques. In the latent variable example, variational Bayes or an EM algorithm may be used.

Hybrid models can perform better than both pure-discriminative and pure-generative models on test data. For example, when using deep hybrid models, the latent variable model can learn a representation used for both predicting an outcome and reconstructing data. A multi-task objective may prevent the latent variable from significantly overfitting on the prediction task. Conversely, adding a discriminative component to the generative model 304 improves an ability of the generative model 304 to represent the data and learn features associated with the data.

As depicted in FIG. 4, the hybrid model 120 can be a linear hybrid model represented as a probabilistic graphical model (PGM) where Z is a latent factor variable of dimension k, taking a value for each observation (n=1, . . . , N) in the data. Z can have a standard joint normal distribution, i.e. Z~ [symbol] (0ₖ, Iₖ). Additionally, for j=1, . . . , r, a data source X^{j} can include continuous explanatory variables

$$( {X}_{1}^{j} , … , {X}_{p ( j )}^{j} )$$

with a multivariate normal distribution whose mean depends on Z via the loading matrix Lⱼ and whose variance is the diagonal matrix ψⱼ, i.e. X^{j}~ [symbol] (LⱼZ, ψⱼ). Y can represent a binary outcome variable, equal to zero or one, and taking value one with probability σ(A^{T}Z+B) where σ is the logistic sigmoid function, i.e. Y~ [symbol] (σ(A^{T}Z+B)). A can represent a vector of length equal to k, the dimension of Z, and B can be a scalar.

By centering model data, an unconditional mean of each X^{j} can be assumed to be zero. Additionally, each explanatory variable

$${X}_{i}^{j}$$

can be assumed to have unconditional variance equal to one, i.e. the explanatory variables have standard Gaussian marginal distributions. Training the hybrid model 120 can involve estimating values of the parameters A, B, Lⱼ (j=1, . . . , r), and ψⱼ (j=1, . . . , r). As described below, a training approach using multi-conditional likelihood can be implemented. The hybrid model 120 can be trained on incomplete data. In particular, any combination of observed variables Y and X^{r} (j=1, . . . , r) can be missing for any given observation.

Applying the hybrid model 120 can enable a prediction of Y for different observations. For each observation, any subset of the data sources X^{r} (j=1, . . . , r) may be observed. If a subset X⁺=(X^{j}^{ₗ}, . . . , X^{j}^{ₛ}) is observed, a posterior probability p (Y=1|X⁺) for the binary outcome variable Y can be specified, as defined below in equations (18)-(20).

$$p ( Y = 1 \vert {X}^{+} ) = \int p ( y = 1 \vert Z ) p ( Z \vert {X}^{+} ) dZ \qquad ( 18 )$$

$$= \int σ ( {A}^{T} Z + B ) p ( Z \vert {X}^{+} ) dZ \qquad ( 19 )$$

$$= E [ σ ( {A}^{T} Z + B ) \vert {X}^{+} ] \qquad ( 20 )$$

The posterior distribution of Z, p(Z|X⁺) can be a multivariate normal, with mean and covariance as defined by equations (21)-(22) below:

$$Cov [ Z \vert {X}^{+} ] = {( I + {L}_{+}^{T} {Ψ}_{+}^{- 1} {L}_{+} )}^{- 1} \text{=:} {G}_{+} \qquad ( 21 )$$

$$E [ Z \vert {X}^{+} ] = {G}_{+} {L}_{+}^{T} {Ψ}_{+}^{- 1} {X}^{+} \qquad ( 22 )$$

L₊ can represent a vertical concatenation of loading matrices Lⱼ for j=j₁, . . . , jₛ, and ψ₊ can represent a diagonal concatenation of matrices ψⱼ. A linear activation A^{T}Z+B can therefore be normally distributed with posterior mean and variance, as defined below by equations (23)-(24):

$$E [ {A}^{T} Z + B \vert {X}^{+} ] = {A}^{T} E [ Z \vert {X}^{+} ] + B \qquad ( 23 )$$

$$Var [ {A}^{T} Z + B \vert {X}^{+} ] = {A}^{T} Cov [ Z \vert {X}^{+} ] A \qquad ( 24 )$$

As sigmoid functions are non-linear, a full integral may not be analytically tractable. However, an approximation can exist for an expected value of a sigmoid function of a normally distributed variable a with mean μ and variance σ², as defined below in equations (25)-(26):

$$E [ σ ( a ) ] \approx σ ( κμ ) \qquad ( 25 )$$

$$κ = {( 1 + \frac{π}{8} {σ}^{2} )}^{- \frac{1}{2}} \qquad ( 26 )$$

A first scaling value

$$\frac{π}{8} \approx 0.393$$

can be used with an assumption that the approximation has a correct gradient at zero. A second scaling value of 0.368 can be used based on an accuracy of the approximation over a range of output values. Applying either of these values can result in suitable values for p(Y=1|X⁺) and log-odds σ⁻¹(p(Y=1|X⁺)). Specifically, using the first scaling value can result in equation (27) below:

$$p ( Y = 1 \vert {X}^{+} ) \approx σ ( \frac{{A}^{T} {G}_{+} {L}_{+}^{T} {Ψ}_{+}^{- 1} {X}^{+} + B}{{( 1 + \frac{π}{8} {A}^{T} {G}_{+} A )}^{\frac{1}{2}}} ) \qquad ( 27 )$$

where, as above,

$${G}_{+} = {( I + {L}_{+}^{T} {Ψ}_{+}^{- 1} {L}_{+} )}^{- 1}$$

and X⁺, L₊ and ψ₊ are the concatenations of Xⱼ, Lⱼ and ψⱼ respectively. When all data sources are observed, X, L and ψ can be written for full concatenations of Xⱼ, Lⱼ and ψⱼ respectively, and G=(1+L^{T}ψ⁻¹L)⁻¹, such that a + notation can be dropped.

In some applications, providing explainability of the hybrid model 120 can be important or necessary. For example, if the hybrid model 120 is used to determine or predict credit risk, the credit risk of a corresponding user can be improved by understanding decision-making of the hybrid model 120. In some aspects, the explainability of the hybrid model 120 can be provided through positivity. For example, given an observation of explanatory variables X=(X₁, . . . , X^{r}), an approximate log-odds or an approximate score can be defined by equations (28)-(29) below:

$${σ}^{- 1} ( E [ σ ( {A}^{T} X + B ) \vert X ] ) \qquad ( 28 )$$

$$\approx κ \cdot ( {A}^{T} {GL}^{T} {Ψ}^{- 1} X + B ) \qquad ( 29 )$$

where κ is positive and does not depend on the value of X. The approximate score can be referred to as “score”. To generate logical explanations for model decisions in terms of the explanatory variables X, the approximate score can be a non-decreasing function of each explanatory variable in X. This may be equivalent to requiring the vector A^{T} GL^{T}ψ⁻¹ to be non-negative. ψ is non-negative by definition, and constraints can be implemented on the entries of L and A. However, G=(I+L^{T}ψ⁻¹L)⁻¹ is formed by inversion of the posterior precision matrix, and non-negativity constraints on L may not lead to a non-negative value of G.

To enforce non-negativity, A^{T}=(A′)^{T}G⁻¹ can be used. Non-negativity of A^{T} GL^{T}ψ⁻¹=(A′)^{T}G⁻¹GL^{T}ψ⁻¹=(A′)^{T}L^{T}ψ⁻¹ can then be enforced by using A′ instead of A as a model parameter. A first constraint on a parameter can include constraining A′ to be non-negative and a subset of the first model parameter (e.g., entries of A′) to be zero. Additionally, a second constraint for enforcing non-negativity can involve constraining locations of a second parameter (e.g., columns of L) corresponding to the non-zero elements of the first parameter to be non-negative. In some aspects, only a first entry in A′ may be non-zero, while a first column of L can be required to be non-negative. This can force all explanatory variables to load non-negatively on a first factor, while the approximate score can represent a non-negative linear combination of observed values of the explanatory variables.

In some aspects, the hybrid model 120 can involve a subset of explanatory variables. For A^{T}=(A′)^{T}G⁻¹, if G represents a posterior covariance matrix of the factors given knowledge of all explanatory variables, and the specified constraints are enforced, then the score κ·(A^{T}GL^{T}ψ⁻¹X+B) can be a non-negative linear function of the observed values X. However, when only a subset X⁺ of the explanatory variables are available, the score can be defined by equation (30) below:

$${κ}^{+} \cdot ( {A}^{T} {G}_{+} {L}_{+}^{T} {Ψ}_{+}^{- 1} {X}^{+} + B ) \qquad ( 30 )$$

which is a non-negative function of X⁺ if and only if

$${A}^{T} {G}_{+} = {( {A}^{′} )}^{T} {G}^{- 1} {G}_{+} {L}_{+}^{T}$$

is non-negative. Alternatively, transpose G₊A can be non-negative. With given constraints on A′ and L, this amounts to a condition on the rows of G⁻¹G₊ which may not be satisfied. If the condition is not satisfied, a different approach of alternative approaches described below may be implemented.

In some aspects, the hybrid model 120 can involve more than one constraint on A. The condition that A′=GA(or (A′)^{T}=A^{T}G) be non-negative, with a subset of entries equal to zero may be extended to A^{T}G⁺ for any subset X⁺ of the explanatory variables. If a small set of combinations X⁺ of explanatory variables can be identified, for which the score is required to be a non-decreasing function of X⁺ when only X⁺ is observed, more than constraint may be imposed on A. Each constraint of the form (G⁺A)ᵢ≥0 can be a linear inequality, while each constraint of the form (G⁺A)ᵢ=0 can be a linear equality constraint. These constraints may be imposed simultaneously in model fitting by repeated projection onto boundary hyperplanes. As the number of chosen subsets X⁺ of the explanatory variables grows, non-zero values of A may not satisfy these constraints. Thus, another approach of the alternative approaches described below may be implemented.

Alternatively, if each explanatory variable loads on only one factor, then the matrices

$${L}_{+}^{T} {Ψ}_{-}^{- 1} {L}_{+}$$

can be diagonal and hence so are

$${G}_{+}^{- 1}$$

and G₊. A hybrid model 120 in which each explanatory variable loads on only one factor can describe discrete subsets of correlated variables, with no correlation between variables in different subsets. In such aspects, non-negativity of A^{T} and A^{T} G₊ can be equivalent conditions for all subsets X⁺. As a result, additional constraints may be imposed. For example, A may be constrained to be non-negative, with a subset of the entries being zero. Additionally, columns of L corresponding to non-zero entries of A may be constrained to be non-negative. Furthermore, entries of L may be constrained such that each row contains one non-zero value. Implementing this can involve prior analysis to produce a prototype matrix as described below.

Implementing implicit imputation-based explanation can be an alternative approach of the alternative approaches. Given observation of a subset of explanatory variables X⁺ and calculation of the posterior distribution p(Z|X⁺), another posterior distribution can be calculated for unobserved variables p(X⁻|X⁺). Since p(Z|X⁺) is Gaussian and p(X⁻|Z) is Gaussian with no conditional dependence on X⁺, a calculation of the posterior mean and covariance of X⁻ can be straightforward. A first approach can involve imputing values for X⁻, for example by setting X⁻=E[X⁻|X⁺], and carrying out the score calculation as if all variables were present.

In some examples, the other posterior estimate for Z, E[Z|X⁺, X⁻=E[X⁻|X⁺]] may not equal the posterior estimate E[Z|X⁺]. Additionally, a posterior precision of Z may increase. How these changes affect the score can be unpredictable. Instead X⁻ can be imputed to a set of values that are relatively likely to leave the score unchanged. Model explanations can then be generated as if all variables were observed, with a caveat that only changes to variables in X⁺, i.e. those that were observed, are considered. In fact, this calculation may be carried out without knowledge of the imputed values. In other words, the model explanations can be generated based on a derivative of a score function if all variables were observed, with respect to the variables that are observed.

In some examples, non-negative least squares (NNLS) can be used to obtain a monotonic score calculation from a subset of data sources (e.g., when other data sources are not available), thereby enabling explainability of the hybrid model 120. Predicting Y can involve using a conditional mean of Z given X⁺, given by

$$E [ Z \vert {X}^{+} ] = {G}_{+} {L}_{+}^{T} {Ψ}_{+}^{- 1} {X}^{+} ,$$

and a conditional mean of A^{T}Z+B given X⁺, given by

$$E [ {A}^{T} Z + B \vert {X}^{+} ] = {A}^{T} {G}_{+} {L}_{+}^{T} {Ψ}_{+}^{- 1} {X}^{+} + B .$$

The conditional means can represent least squares estimators of Z and A^{T}Z+B. As functions of X⁺, the conditional means can minimize expected squared errors E[∥UX⁺−Z∥²] and E[((WX⁺+B)−(A^{T}Z+B))²]=E[(WX⁺−A^{T} Z)²], respectively. However, as linear operators, the conditional means may have negative coefficients and therefore, as observed above, the conditional means may not be non-decreasing in each variable in X⁺. Other estimators of Z and A^{T}Z given X⁺ may exist. In particular, non-negative least squares (NNLS) can be used to find a linear estimator of smallest variance that has no negative coefficients.

To implement NNLS in the hybrid model 120, a linear operator N with non-negative coefficients can be used to minimize an expected squared loss E[(NX⁺−A^{T}Z)²]=Var[NX⁺−A^{T} Z]. An additive constant B may be added to form an estimator NX⁺+B of A^{T}Z+B. Expanding the variance can result in equation (31), as defined below:

$$Var [ {NX}^{+} - {A}^{T} Z ] = {A}^{T} A + 2 [ \frac{1}{2} N ( {L}_{+} {L}_{+}^{T} + {Ψ}_{+} ) {N}^{T} - {A}^{T} {L}_{+}^{T} {N}^{T} ] [ \frac{1}{2} N ( {L}_{+} {L}_{+}^{T} + {Ψ}_{+} ) {N}^{T} - {A}^{T} {L}_{+}^{T} {N}^{T} ] \qquad ( 31 )$$

can have a form similar to equation (32) defined below:

$$\frac{1}{2} {x}^{T} Q x + {c}^{T} x \qquad ( 32 )$$

where x=N^{T},

$${c}^{T} = - {A}^{T} {L}_{+}^{T} , and Q = {L}_{+} {L}_{+}^{T} + {Ψ}_{+}$$

which is symmetric and positive semi-definite. This is a standard form of NNLS expressed as a quadratic programming problem. The quadratic programming problem may also be expressed in the more common NNLS form as minimizing

$${‖ Rx - y ‖}_{2}^{2} where x = {N}^{T} , {R}^{T} R = {L}_{+} {L}_{+}^{T} + {Ψ}_{+} ,$$

and y=LA(R^{T})⁻¹. R can be obtained via a Cholseky decomposition. Therefore, any NNLS algorithm can be applied to solve for N, given A, L₊ and ψ₊.

Once a value for N has been found, NX⁺ can be used as an estimator of A^{T}Z given X⁺. In order to predict Y from X⁺, a predictive distribution for A^{T}Z, including a variance Var[A^{T}Z−NX⁺], can be used. The variance can be given by an expression for an identical variance Var[NX⁺−A^{T}Z] above and may not depend on a specific value of X⁺. If the NNLS method is to be used, constraints may not be applied when fitting the hybrid model 120. Explanatory variables in X that have a positive correlation with the outcome Y can be relatively likely to load positively on a rotated factor A^{T}Z that acts as a predictor of Y. Non-negative predictors of A^{T}Z from any subset X⁺ of the explanatory variables may then be derived via NNLS, and can be expected to have relativley reasonable performance due to the positive correlations. However, the non-negativity constraints on A′ and L described for more than one constraint on A may be applied to ensure that the estimator of A^{T}Z given all of the explanatory variables X is the true expected value E[A^{T} Z|X].

In summary, implementing NNLS can first involve fitting the hybrid model 120 with or without constraints on A′=GA and L to ensure positivity of the estimator of A^{T}Z given X. For each subset of explanatory variables X⁺ encountered during model application, an NNLS algorithm can be applied to find a non-negative linear operator N₊X⁺ minimizing E[(N₊X⁺−A^{T}Z)²]. Additionally,

$${σ}_{+}^{2} : = Var [ {A}^{T} Z - {N}_{+} {X}^{+} ]$$

can be determined using equations described above. These estimators may be determined in advance or calculated as required and cached in the model application. To predict Y from X⁺, a corresponding NNLS estimator N⁺X⁺ can be used. Additionally, predicting Y from X⁺ can involve assuming

$$A {T}^{Z} + B ∼ 𝒩 ( {N}_{+} {X}^{+} + B , {σ}_{+}^{2} )$$

and using an approximation for an expected value of a sigmoid of a normally distributed variable p(Y=1|X⁺)=E[σ(AT^{Z}+B)]≈σ(κ(N₊X⁺+B)) where

$$κ = {( 1 + \frac{π}{8} {σ}_{+}^{2} )}^{- \frac{1}{2}} .$$

In some aspects, using interpretable factors can enable explainability of the hybrid model 120. The approach to explainability through positivity described above can suffer from complications when data sources may be missing. Ensuring positivity of the score for multiple combinations of observed data sources may place multiple constraints on the model parameters, which may ultimately be impossible to satisfy. Alternatively, generating explanations as if all data sources were present may produce results that are incorrect. Thus, implementing a different approach may circumvent these disadvtanges. The different approach may involve generating model explanations in terms of a calculated posterior mean of the factor vector Z, i.e. the factor scores. The calculated posterior mean may be restricted to a subset of the factors that influence the score. In this approach, the score can be directly expressed as a function of the latent factors.

The model score, or approximate log-odds, can be defined by equations (33)-(34) below:

$${σ}^{- 1} ( E [ σ ( {A}^{T} Z + B ) \vert X ) ] \qquad ( 33 )$$

$$= κ \cdot ( {A}^{T} \hat{Z} + B ) \qquad ( 34 )$$

where the value of κ depends only on which data sources are available. This can represent a linear function of \hat{Z}=E[Z|X⁺], enabling model explanations generated via either a points-below-max approach or integrated gradients. The points-below-max approach can involve calculating a change in score that would arise from a change in each factor value separately. Using the integrated gradients can involve allocating the difference in score between the current set of factor values and a reference point across the factors. For these explanations to be meaningful, more than condition can be necessary. For example, a first condition can involve factors that influence the score having interpretations that make sense of the explanatory variables that load on them. In some aspects, there may be factors in the hybrid model 120 that do not influence the score, and these factors may not be interpretable. Additonally, a second condition can involve a derivative of the score with respect to each factor being consistent with an expected direction of influencing the score.

Given a set of factor loading matrices with interpretable factors, achieving the second condition can only involve applying constraints to the vector A. The constraints can include non-negativity constraints for the interpretable factors that are permitted to influence the score and zero constraints for non-interpretable factors. However, optimization of the factor loading matrices Lⱼ for predictive performance can be included in the model fitting process such that the factor loading matrices are relatively unlikely to be known apriori. Instead, a set of prototype loading matrices in the form of constraints can be applied to elements of each Lⱼ. Specifically, an i-th column of Lⱼ can contain loadings for each variable in X^{j} on an i-th factor, and each of these entries may be constrained to be non-negative, non-positive, or zero in order to enforce a particular interpretation on the i-th factor.

Obtaining the prototype loading matrices can involve prior analysis. One example of the prior analysis can include performing an exploratory factor analysis, followed by a rotation (e.g., a varimax rotation) designed to produce loading matrices with a small number of large loadings. In additional or alternative examples, the prior analysis can include performing an exploratory factor analysis with L1 regularization, which may produce loading matrices with insignificant loadings shrunk to zero. Another example of the prior analysis can involve performing a preliminary fit of the hybrid model 120 without constraints, and applying varimax rotation to resulting factor loading matrices. Performing a preliminary fit of the hybrid model 120 with L1 regularization for the loading matrices can be yet another example of the prior analysis. This process can involve a trivial addition to the model loss function. Having obtained an initial interpretable factor decomposition, a final fit of the hybrid model 120 can be carried out in which insignificant factor loadings can be constrained to zero, significant loadings can receive sign constraints, and appropriate constraints can be applied to the scoring vector A.

As described above, the hybrid model 120 can be defined mathematically using a set of latent factor variables Z of dimension k, distributed standard normal Z~ [symbol] (0ₖ, Iₖ) with factor loading matrices L; for each explanatory data source X^{j}. X^{j}~ [symbol] (LⱼZ, ψⱼ) where ψⱼ is diagonal. Additionally, a binary outcome variable Y can be referred to as an output of the hybrid model 120 and can have a logit that is a linear combination of the factors, i.e. Y~ [symbol] (σ(A^{T}Z+B)). For any given observation, one or more of data sources X^{j} may be observed. In some aspects, an assumption can be made that a presence or absence of each data source is completely random, i.e. uncorrelated with the values of the other data sources or Y. Log-likelihood for the observed variables as a function of the parameters Θ={Lⱼ, ψⱼ, A, B} can involve integrating over the distribution of Z, as defined by equations (35)-(36) below:

$$\begin{matrix}log p ( X , Y \vert Θ ) = log \int p ( X , Y \vert Z , Θ ) p ( Z \vert Θ ) dZ \\ = log \int {\prod }_{j} p ( {X}^{j} \vert Z , Θ ) p ( Y \vert Z , Θ ) p ( Z ) dZ ( 36 )\end{matrix} \qquad ( 35 )$$

Fitting the hybrid model 120 can involve adjusting an importance of each data source X^{j} and the outcome variable Y in the loss function, enabling different degrees of priority to be assigned to the level of fit between the factors Z and each of the data sources. Additionally, fitting the hybrid model 120 can enable a prediction of the outcome variable to be prioritized. Thus, the hybrid model 120 can be defined by equations (37)-(38) below:

$$\begin{matrix}Log L ( X , Y \vert Θ ) = log \int L ( X , Y , Z \vert Θ ) dZ \\ = log \int {\prod }_{j} {p ( {X}^{j} \vert Z , Θ )}^{{α}_{j}} {p ( Y \vert Z , Θ )}^{β} p ( Z ) dZ ( 38 )\end{matrix} \qquad ( 37 )$$

An expected gradient algorithm, which is a variation on an expectation-maximizaiton algorithm, can be applied, as defined below in equations (39)-(41):

$$\begin{matrix}\frac{\partial }{\partial Θ} log L ( X , Y \vert Θ ) = \frac{1}{L ( X , Y \vert Θ )} \frac{\partial }{\partial Θ} \int L ( X , Y , Z \vert Θ ) dZ \\ = \int \frac{L ( X , Y , Z \vert Θ )}{L ( X , Y \vert Θ )} \frac{\partial }{\partial Θ} log L ( X , Y , Z \vert Θ ) dZ ( 40 ) \\ = \int L ( Z \vert X , Y , Θ ) \frac{\partial }{\partial Θ} log L ( X , Y , Z \vert Θ ) dZ ( 41 )\end{matrix} \qquad ( 39 )$$

where L(Z|X, Y, Θ) is defined below as equation (42):

$$\begin{matrix}L ( Z \vert X , Y , Θ ) = \frac{L ( X , Y , Z \vert Θ )}{L ( X , Y \vert Θ )} \\ = \frac{{\prod }_{j} {p ( {X}^{j} \vert Z , Θ )}^{{α}_{j}} {p ( Y \vert Z , Θ )}^{β} p ( Z )}{\int {\prod }_{j} {p ( {X}^{j} \vert Z , Θ )}^{{α}_{j}} {p ( Y \vert Z , Θ )}^{β} p ( Z ) d Z}\end{matrix} \qquad ( 42 )$$

L(Z|X, Y, Θ) can be interpreted as a posterior distribution Z~l(Z|X, Y, Θ) with respect to a hybrid complete data distribution l(X, Y, Z|Θ)∝L(X, Y, Z|Θ)=Πⱼ p(X^{j}|Z, Θ)^{α}^{ⱼ}p(Y|Z, Θ)^{β}p(Z). In some aspects, L(X, Y, Z|Θ) may fail to be normalized, but this can be accounted for by introducing a normalisation term that depends only on Θ to both a numerator and a denominator of an expression for L(Z|X, Y, Θ). As a result, L(Z|X, Y, Θ) can cancel so that L(X, Y, Z|Θ)=Πⱼ p(X^{j}|Z, Θ)^{α}^{ⱼ}p(Y|Z, Θ)^{β}p(Z)C(Θ) remains. In such aspects, equation (43) below can be obtained:

$$\frac{\partial }{\partial Θ} log L ( X , Y \vert Θ ) = {E}_{Z ∼ l ( Z \vert X , Y , Θ )} [ \frac{\partial }{\partial Θ} log L ( X , Y , Z \vert Θ ) ] \qquad ( 43 )$$

In other words, a gradient of a loss function −log L(X, Y|Θ) may be an expected gradient of a complete data loss function −log L(X, Y, Z|Θ) taken over Z~l(Z|X, Y, Θ). An algorithm associated with the hybrid model 120 therefore can include a series of “EG” steps. These “EG” steps may be run on mini-batches of the data using a gradient-based optimizer, such as Adam. An E step of the algorithm can involve calculating sufficient statistics of a posterior distribution Z~l(Z|X, Y, Θ). Specifically, the E step can involve calculating the first and second moments, i.e. a joint mean and covariance of the posterior distribution of the latent factor variable Z, given current parameter values. A prior distribution for Z can be a standard Gaussian distribution that can be updated to account for each observed explanatory data source X^{j} and for the observed outcome variable Y.

Updating the distribution of Z for the observed variables X^{j} can involve calculating a posterior covariance matrix, as defined below by equation (44):

$$G = Cov [ Z \vert X ] = {( I + {\sum }_{j} {α}_{j} {L}_{j}^{T} {Ψ}_{j}^{- 1} {L}_{j} )}^{- 1} \qquad ( 44 )$$

and a posterior mean, as defined below by equation (45):

$$E [ Z \vert X ] = G {\sum }_{j} {α}_{j} {L}_{j}^{T} {Ψ}_{j}^{- 1} {X}^{j} \qquad ( 45 )$$

where sums in equations (44) and (45) are taken over the data sources X^{j} that are present for each observation. Equations (44) and (45) can be used to derive equation (46) as defined below:

$$E [ {ZZ}^{T} \vert X ] = G + E [ Z \vert X ] {E [ Z \vert X ]}^{T} \qquad ( 46 )$$

Importance parameters αⱼ may increase a precision of an update taken from each data source, in essence treating a value of X^{j} as if it were the mean of αⱼ separate observations.

Since p(Y|Z)=σ(A^{T}Z+B) is not an exponential function of a quadratic in Z, a true hybrid posterior distribution l(Z|X, Y) may not be Gaussian. Thus, calculating a mean and a covariance of the true hybrid posterior distribution can be analytically intractable. However, good approximations exist that can involve approximating log p(Y|Z) by a quadratic in Z. A variational ξ method can be implemented by iteratively updating a new parameter ξ for each observation to achieve an optimal approximation. Alternatively, an S-L approximation can be implemented by using a second-order Taylor series expansion for log p(Y|Z) around a prior mean (e.g., E[Z|X]) and taking a single Fisher-Newton update step to find an approximate value for a posterior mean. By incorporating an importance parameter β, an update rule can be defined by equations (47)-(48) below:

$$Cov [ Z \vert X , Y ] = {( {Cov [ Z \vert X ]}^{- 1} + β \hat{p} ( 1 - \hat{p} ) {AA}^{T} )}^{- 1} \qquad ( 47 )$$

$$E ( Z \vert X , Y ) = E [ Z \vert X ] + β ( Y - \hat{p} ) Cov [ Z \vert X , Y ] A \qquad ( 48 )$$

where \hat{p}=σ(E[AZ+B|X])=σ(AE[Z|X]+B). An accuracy of the S-L approximation can improve as a precision of a prior distribution of Z increases, i.e. as Cov[Z|X] decreases. This can be expected to happen as a model fit improves, so scale parameters ψⱼ may become small. Updating for X before updating for Y can enable an improving approximation for E[Z|X, Y] to be used.

A G step of the algorithm can involve calculating an expected gradient of a complete data loss function

$${E}_{Z ∼ l ( Z \vert X , Y , Θ )} [ - \frac{\partial }{\partial Θ} log L ( X , Y , Z \vert Θ ) ]$$

and taking a gradient step. Specifically, the G step can involve calculating an expected value of a gradient of the complete data loss function where an expectation is taken over a posterior distribution of a latent factor variable Z under current parameter values, as determined in the E step. Current parameter values can be treated as constant values for calculating the expectation, whereas other parameter values can represent variables in the loss function, with respect to which the gradient is calculated. By denoting the current parameter values using Θ₀, equations (49)-(50) can be defined as below:

$$\begin{matrix}\frac{\partial }{\partial Θ} {\vert}_{Θ = {Θ}_{0}} log L ( X , Y \vert Θ ) = {E}_{Z ∼ l ( Z \vert X , Y , {Θ}_{0} )} [ \frac{\partial }{\partial Θ} log L ( X , Y , Z \vert Θ ) ] \\ = \frac{\partial }{\partial Θ} {\vert}_{Θ = {Θ}_{0}} {E}_{Z ∼ l ( Z \vert X , Y , {Θ}_{0} )} [ log L ( X , Y , Z \vert Θ ) ] ( 50 )\end{matrix} \qquad ( 49 )$$

Therefore, the G step can be reduced to a problem of specifying a closed form mathematical expression for an expectation of a loss function and then taking a gradient. Calculating the gradient can be relatively straightforward and can be carried out automatically by a framework, such as Tensorflow. Equation (51) defined below for the expected loss can be derived using a similar approximation for a sigmoid transformation of a normally distributed variable as described above for predicting Y:

$${E}_{Z ∼ l ( Z \vert X , Y , {Θ}_{0} )} [ - log L ( X , Y , Z \vert Θ ) ] = \frac{k}{2} log ( 2 π ) + \frac{1}{2} TrE ( {ZZ}^{T} ) + {\sum }_{j} {α}_{j} ( \frac{{p}_{j}}{2} log ( 2 π ) + \frac{1}{2} log \vert {Ψ}_{j} \vert + \frac{1}{2} {‖ {Ψ}_{j}^{- \frac{1}{2}} {X}^{j} ‖}^{2} - {E [ Z ]}^{T} {L}_{j}^{T} {Ψ}_{j}^{- 1} {X}^{j} + \frac{1}{2} Tr ( E ( {ZZ}^{T} ) {L}_{j}^{T} {Ψ}_{j}^{- 1} {L}_{j}^{T} ) ) - βlog σ ( κ ( {A}^{T} Cov [ Z ] A ) ( {A}^{T} Z + B ) ( 2 Y - 1 ) ) \qquad ( 51 )$$

A sum in equation (51) can be taken only over one or more explanatory data sources X^{j} that are present for each observation. Although the G step is described with respect to the approximation described above, other approximations can be used for an expected log sigmoid.

In some aspects, an additional complication can be introduced when some of the explanatory data sources are missing. In such aspects, a corresponding portion of the loss function can be eliminated to generate a partial loss function. For example, if X^{j} is missing, equation (52), defined below, can be used:

$$log L ( \{ {X}^{i} \vert i \neq j \} , Y \vert Θ ) = log \int {\prod }_{i \neq j} {p ( {X}^{i} \vert Z , Θ )}^{{α}_{i}} {p ( Y \vert Z , Θ )}^{β} p ( Z ) d Z \qquad ( 52 )$$

Integrating out X^{j} may instead yield equation (53) as defined below:

$$log \int L ( X , Y , Z \vert Θ ) d {X}^{j} d Z = log \int [ \int {p ( {X}^{j} \vert Z , Θ )}^{{α}_{j}} d {X}^{j} ] {\prod }_{i \neq j} {p ( {X}^{i} \vert Z , Θ )}^{{α}_{i}} {p ( Y \vert Z , Θ )}^{β} p ( Z ) dZ = log \int D ( Z , Θ ) {\prod }_{i \neq j} {p ( {X}^{i} \vert Z , Θ )}^{{α}_{i}} {p ( Y \vert Z , Θ )}^{β} p ( Z ) d Z \qquad ( 53 )$$

where D(Z, Θ) is a normalization term, since p(X^{j}|Z, Θ)^{α}^{ⱼ} may fail to be a density function. As defined in equation (52), p(X^{j}|Z, Θ) may be Gaussian, with Z contributing only to a location parameter, so D(Z, Θ)=∫p(X^{j}|Z, Θ)^{α}^{ⱼ}dX^{j} does not depend on Z. The two expressions therefore can differ additively by a function of Θ. Specifically, the difference between the two expressions can depend on a scale parameter ψⱼ. An alternative approach, that does not introduce the function of Θ, can involve calculating posterior moments of missing variables in the E-step along with the latent factor values, and incorporating these values in the expected gradient calculation. Implementing this alternative approach may be relatively straightforward since the explanatory variables are assumed to have a Gaussian conditional distribution. Using a similar derivation as described above, equation (54) can be as defined below:

$$\frac{\partial }{\partial Θ} log L ( \{ {X}^{i} \vert i \neq j \} , Y \vert Θ ) = {E}_{Z ∼ l ( Z \vert \{ {X}^{i} \vert i \neq j \} , Y , Θ )} [ \frac{\partial }{\partial Θ} log L ( \{ {X}^{i} \vert i \neq j \} , Y , Z \vert Θ ) ] \qquad ( 54 )$$

that is, a gradient of the loss function is the expected gradient of the partial complete data loss function, as defined below by equation (55):

$$- log {\prod }_{i \neq j} {p ( {X}^{i} \vert Z , Θ )}^{{α}_{i}} {p ( Y \vert Z , Θ )}^{β} p ( Z ) \qquad ( 55 )$$

taken over the hybrid posterior, as defined below by equation (56):

$$Z ∼ l ( Z \vert \{ {X}^{i} \vert i \neq j \} , Y , Θ ) ∝ {\prod }_{i \neq j} {p ( {X}^{i} \vert Z , Θ )}^{{α}_{i}} {p ( Y \vert Z , Θ )}^{β} p ( Z ) \qquad ( 56 )$$

A hyperparameter of the hybrid model 120 can be a parameter whose value is used to control a learning process of the hybrid model 120. Hyperparameter tuning can be implemented to determine a set of optimal hyperparameters for the learning process of the hybrid model 120. In some aspects, the Akaike Information Criterion (AIC) can be used, in particular for a final model for fixed values of importance parameters αᵢ and β. AIC may be formulated in terms of log-likelihood. A hybrid loss function can be defined by equation (57) below:

$$\begin{matrix}- log L ( X , Y \vert Θ ) = - log \int L ( X , Y , Z \vert Θ ) dZ \\ = - log \int {\prod }_{j} {p ( {X}^{j} \vert Z , Θ )}^{{α}_{j}} {p ( Y \vert Z , Θ )}^{β} p ( Z ) dZ\end{matrix} \qquad ( 57 )$$

and can be interpreted as a log-likelihood where each data item X^{j} or Y is replicated αⱼ or β times, respectively. The AIC then can take a form 2K−2L(X, Y|\hat{Θ}), where K is the number of degrees of freedom in the hybrid model 120 and \hat{Θ} is the MLE of Θ. The hybrid model 120 with k factors and p explanatory variables can have kp+p+k+1=(k+1)(p+1) parameters, but relatively fewer degrees of freedom. This can result from values of factor loading matrices {Lⱼ} being determined only up to an orthogonal rotation of the factors, which removes

$$\frac{k ( k - 1 )}{2}$$

degrees of freedom. If linear equality constraints are applied to the entries of A (or A′ as above) to enforce monotonicity, then the degrees of freedom in the hybrid model 120 can be further reduced.

Changing values of the importance parameters αⱼ and β can change a hybrid loss function log L(X,Y|Θ) so that values of hybrid loss for different parameter values may not be easily comparable. To determine optimal values of αⱼ and β, a predictive performance of the model can be assessed via a predictive log-likelihood. As described above, a model prediction, given observed values of data sources X⁺, can be defined by equation (58) below:

$$p ( Y = 1 \vert {X}^{+} ) = E [ σ ( {A}^{T} Z + B ) \vert {X}^{+} ] \qquad ( 58 )$$

and an approximation can be used for an integral over a Gausssian distribution to integrate over a Gaussian posterior distribution for Z. A predictive loss function can represent an average of negative log probabilities

$$\frac{1}{N} {\sum }_{n} - log p ( Y = {y}_{n} \vert {X}_{\cdot n}^{+} ) ,$$

which can be evaluated over any training sample (e.g., the model training samples 126 of FIG. 1) or test sample that may or may not be weighted. In order to ensure the hybrid model 120 is optimized for prediction of an outcome variable when data sources are missing, the traing sample or test sample used to tune the importance parameters may contain examples with differing subsets of data sources available. The examples may be sampled from a real population and weighted to reflect a population distribution of data source availability. Alternatively, the examples can be reweighted to ensure coverage of different combinations of data sources. In additional or alternative examples, synthetic examples can be created from real data by making some data sources artificially unavailable.

### Example of Computing System for Machine-Learning Operations

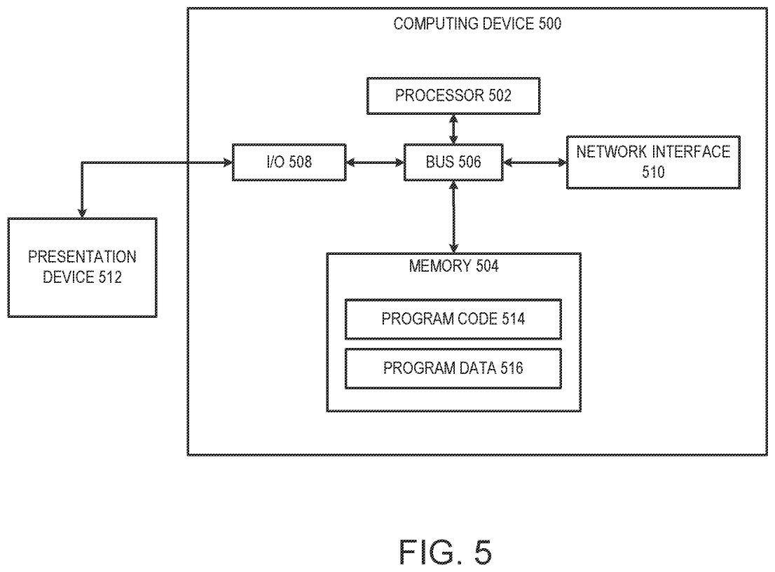

Any suitable computing system or group of computing systems can be used to perform the operations for the machine-learning operations described herein. For example, FIG. 5 is a block diagram depicting an example of a computing device 500, which can be used to implement the risk assessment server 118 or the model training server 110. The computing device 500 can include various devices for communicating with other devices in the operating environment 100, as described with respect to FIG. 1. The computing device 500 can include various devices for performing one or more transformation operations described above with respect to FIGS. 1-4.

The computing device 500 can include a processor 502 that is communicatively coupled to a memory 504. The processor 502 executes computer-executable program code stored in the memory 504, accesses information stored in the memory 504, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 502 include a microprocessor, an application-specific integrated circuit, a field-programmable gate array, or any other suitable processing device. The processor 502 can include any number of processing devices, including one. The processor 502 can include or communicate with a memory 504. The memory 504 stores program code that, when executed by the processor 502, causes the processor to perform the operations described in this disclosure.

The memory 504 can include any suitable non-transitory computer-readable storage medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 500 may also include a number of external or internal devices such as input or output devices. For example, the computing device 500 is shown with an input/output interface 508 that can receive input from input devices or provide output to output devices. A bus 506 can also be included in the computing device 500. The bus 506 can communicatively couple one or more components of the computing device 500.

The computing device 500 can execute program code 514 that includes the risk assessment application 114 and/or the model training application 112. The program code 514 for the risk assessment application 114 and/or the model training application 112 may be resident in any suitable computer-readable medium and may be executed on any suitable processing device. For example, as depicted in FIG. 5, the program code 514 for the risk assessment application 114 and/or the model training application 112 can reside in the memory 504 at the computing device 500 along with the program data 516 associated with the program code 514, such as the predictor variables 124 and/or the model training samples 126. Executing the risk assessment application 114 or the model training application 112 can configure the processor 502 to perform the operations described herein.

In some aspects, the computing device 500 can include one or more output devices. One example of an output device is the network interface device 510 depicted in FIG. 5. A network interface device 510 can include any device or group of devices suitable for establishing a wired or wireless data connection to one or more data networks described herein. Non-limiting examples of the network interface device 510 include an Ethernet network adapter, a modem, etc.

Another example of an output device is the presentation device 512 depicted in FIG. 5. A presentation device 512 can include any device or group of devices suitable for providing visual, auditory, or other suitable sensory output. Non-limiting examples of the presentation device 512 include a touchscreen, a monitor, a speaker, a separate mobile computing device, etc. In some aspects, the presentation device 512 can include a remote client-computing device that communicates with the computing device 500 using one or more data networks described herein. In other aspects, the presentation device 512 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A method performed by one or more processing devices, comprising:
determining, using a hybrid machine learning model trained using a training process, a risk indicator for a target entity from predictor variables associated with the target entity, wherein the risk indicator indicates a level of risk associated with the target entity, wherein the training process includes operations comprising:
accessing training vectors having a plurality of sets of training predictor variables and a plurality of training outputs corresponding to the respective sets of training predictor variables; and
performing iterative adjustments of parameters of the hybrid machine learning model to minimize a loss function of the hybrid machine learning model, wherein the loss function comprises a first term representing a discriminative loss and a second term representing a generative loss, wherein a value of a predictor variable in the predictor variables associated with the target entity is unknown or a value of a training predictor variable or a training output in the training vectors is unknown;
generating, for the target entity, explanatory data indicating relationships between changes in the risk indicator and changes in at least some of the predictor variables associated with the target entity; and
transmitting, to a remote computing device, a responsive message including at least the risk indicator and the explanatory data for use in controlling access of the target entity to one or more interactive computing environments.

2. The method of claim 1, wherein the hybrid machine learning model is trained under a constraint that an output of the hybrid machine learning model is monotonic to each predictor variable, and wherein the constraint comprises a first constraint on a parameter to be non-negative and a subset of a first model parameter to be zero and a second constraint on a second parameter to be non-negative at locations corresponding to non-zero elements of the first model parameter.

3. The method of claim 1, wherein the hybrid machine learning model comprises a set of latent factor variables, a plurality of sets of predictor variables generated from a plurality of data sources, and an output, wherein each set of the predictor variables have a distribution dependent on the set of latent factor variables via a loading matrix.

4. The method of claim 3 wherein the hybrid machine learning model is trained under a constraint that an output of the hybrid machine learning model is monotonic to each latent factor variable that influence the output.

5. The method of claim 4, wherein the operations further comprise, prior to performing the iterative adjustments of parameters of the hybrid machine learning model, obtaining a set of prototype loading matrices with the constraint imposed, and wherein obtaining the set of prototype loading matrices comprises one or more of:
performing a factor analysis on the predictor variables; or
performing a preliminary training of the hybrid machine learning model.

6. The method of claim 1, wherein the predictor variables associated with the target entity comprise a first subset of predictor variables that are available and a second subset of predictor variables that are unknown, and wherein determining the risk indicator for the target entity comprises determining the risk indicator based on a non-negative linear operator that corresponds to the first subset of the predictor variables.

7. The method of claim 6, wherein the non-negative linear operator for the first subset of the predictor variables associated with the target entity is determined by applying a non-negative least square algorithm.

8. A system comprising:
a processing device; and
a memory device in which instructions executable by the processing device are stored for causing the processing device to:
determine, using a hybrid machine learning model trained using a training process, a risk indicator for a target entity from predictor variables associated with the target entity, wherein the risk indicator indicates a level of risk associated with the target entity, wherein the training process includes operations comprising:
accessing training vectors having a plurality of sets of training predictor variables and a plurality of training outputs corresponding to the respective sets of training predictor variables; and
performing iterative adjustments of parameters of the hybrid machine learning model to minimize a loss function of the hybrid machine learning model, wherein the loss function comprises a first term representing a discriminative loss and a second term representing a generative loss, wherein a value of a predictor variable in the predictor variables associated with the target entity is unknown or a value of a training predictor variable or a training output in the training vectors is unknown;
generate, for the target entity, explanatory data indicating relationships between changes in the risk indicator and changes in at least some of the predictor variables associated with the target entity; and
transmit, to a remote computing device, a responsive message including at least the risk indicator and the explanatory data for use in controlling access of the target entity to one or more interactive computing environments.

9. The system of claim 8, wherein the hybrid machine learning model is trained under a constraint that an output of the hybrid machine learning model is monotonic to each predictor variable, and wherein the constraint comprises a first constraint on a parameter to be non-negative and a subset of a first model parameter to be zero and a second constraint on a second parameter to be non-negative at locations corresponding to non-zero elements of the first model parameter.

10. The system of claim 8, wherein the hybrid machine learning model comprises a set of latent factor variables, a plurality of sets of predictor variables generated from a plurality of data sources, and an output, wherein each set of the predictor variables have a distribution dependent on the set of latent factor variables via a loading matrix.

11. The system of claim 10, wherein the hybrid machine learning model is trained under a constraint that an output of the hybrid machine learning model is monotonic to each latent factor variable that influence the output.

12. The system of claim 11, wherein the operations further comprise, prior to performing the iterative adjustments of parameters of the hybrid machine learning model, obtaining a set of prototype loading matrices with the constraint imposed, and wherein obtaining the set of prototype loading matrices comprises one or more of:
performing a factor analysis on the predictor variables; or
performing a preliminary training of the hybrid machine learning model.

13. The system of claim 8, wherein the predictor variables associated with the target entity comprise a first subset of predictor variables that are available and a second subset of predictor variables that are unknown, and wherein determining the risk indicator for the target entity comprises determining the risk indicator based on a non-negative linear operator that corresponds to the first subset of the predictor variables.

14. The system of claim 13, wherein the non-negative linear operator for the first subset of the predictor variables associated with the target entity is determined by applying a non-negative least square algorithm.

15. A non-transitory computer-readable storage medium having program code that is executable by a processor to cause a computing device to perform operations, the operations comprising:
determining, using a hybrid machine learning model trained using a training process, a risk indicator for a target entity from predictor variables associated with the target entity, wherein the risk indicator indicates a level of risk associated with the target entity, wherein the training process comprises:
accessing training vectors having a plurality of sets of training predictor variables and a plurality of training outputs corresponding to the respective sets of training predictor variables;
performing iterative adjustments of parameters of the hybrid machine learning model to minimize a loss function of the hybrid machine learning model, wherein the loss function comprises a first term representing a discriminative loss and a second term representing a generative loss, wherein a value of a predictor variable in the predictor variables associated with the target entity is unknown or a value of a training predictor variable or a training output in the training vectors is unknown;
generating, for the target entity, explanatory data indicating relationships between changes in the risk indicator and changes in at least some of the predictor variables associated with the target entity; and
transmitting, to a remote computing device, a responsive message including at least the risk indicator and the explanatory data for use in controlling access of the target entity to one or more interactive computing environments.

16. The non-transitory computer-readable storage medium of claim 15, wherein the hybrid machine learning model is trained under a constraint that an output of the hybrid machine learning model is monotonic to each predictor variable, and wherein the constraint comprises a first constraint on a parameter to be non-negative and a subset of a first model parameter to be zero and a second constraint on a second parameter to be non-negative at locations corresponding to non-zero elements of the first model parameter.

17. The non-transitory computer-readable storage medium of claim 16, wherein the hybrid machine learning model comprises a set of latent factor variables, a plurality of sets of predictor variables generated from a plurality of data sources, and an output, wherein each set of the predictor variables have a distribution dependent on the set of latent factor variables via a loading matrix.

18. The non-transitory computer-readable storage medium of claim 17, wherein the hybrid machine learning model is trained under a constraint that an output of the hybrid machine learning model is monotonic to each latent factor variable that influence the output.

19. The non-transitory computer-readable storage medium of claim 15, wherein the predictor variables associated with the target entity comprise a first subset of predictor variables that are available and a second subset of predictor variables that are unknown, and wherein determining the risk indicator for the target entity comprises determining the risk indicator based on a non-negative linear operator that corresponds to the first subset of the predictor variables.

20. The non-transitory computer-readable storage medium of claim 19, wherein the non-negative linear operator for the first subset of the predictor variables associated with the target entity is determined by applying a non-negative least square algorithm.
